(19) United States
(12) Patent Application Publication
(10) Pub. No.: US 2015/0095667 A1
(43) Pub. Date: Apr. 2, 2015

(54) MANAGING COMPONENT PERFORMANCE

(71) Applicants: GREGORY A. NIELSEN, Tsukuba (JP); ALEXANDER D. WILLIAMS, DuPont, WA (US); GAVIN D. STANLEY, Puyallup, WA (US); KETAN R. SHAH, Olympia, WA (US)

(72) Inventors: GREGORY A. NIELSEN, Tsukuba (JP); ALEXANDER D. WILLIAMS, DuPont, WA (US); GAVIN D. STANLEY, Puyallup, WA (US); KETAN R. SHAH, Olympia, WA (US)

(21) Appl. No.: 14/039,740

(22) Filed: Sep. 27, 2013

(51) Int. Cl. G06F 1/20

(52) U.S. Cl. CPC G06F 1/206
USPC 713/300

(57) ABSTRACT

A method for managing component performance is described. The method includes determining an angle of a computer processor with respect to gravity. The electronic device includes a computer processor. A parameter is selected for the computer processor. A speed of the computer processor is based on the parameter. A value of the parameter is selected based on the angle. The value of the parameter is set based on the selection.

### TECHNICAL FIELD

This disclosure relates generally to managing component performance and more specifically, but not exclusively, to managing the performance of components of mobile computing devices.

### BACKGROUND ART

In mobile computing devices, such as tablets and convertibles, the performance of various components, such as a central processing unit (CPU), is related to the device's thermal capability. The thermal capability is the ability of such a device to dissipate heat. The heat generated by these devices increases along with the power consumed by the various components. As such, the power supplied to the components may be constrained when they become heated. Constraining power to a component constrains the performance of the components.

One approach involves using a skin temperature monitoring sensor, and dynamically controlling CPU performance. However, this approach is costly, and complex. Another approach involves predefining static power limits as a way to limit the heat generated, and to allow the device to dissipate heat efficiently. However, these static limits make assumptions about how the devices are used. When the actual environment is different from the assumed environment, the performance of the device may be constrained beyond what is useful for the actual environment.

### BRIEF DESCRIPTION OF THE DRAWING

FIG. 1 is a graph showing thermal capability with respect to device position, in accordance with embodiments;

FIG. 2 is a schematic diagram of a system for managing component performance, in accordance with embodiments;

FIG. 3 is a graph showing power dissipation capability with respect to device angle and position, in accordance with embodiments;

FIGS. 4A-B are block diagrams of a system for managing component performance, in accordance with embodiments; and

FIG. 5 is a process flow diagram 500 showing a method for managing component performance of an electronic device, in accordance with embodiments.

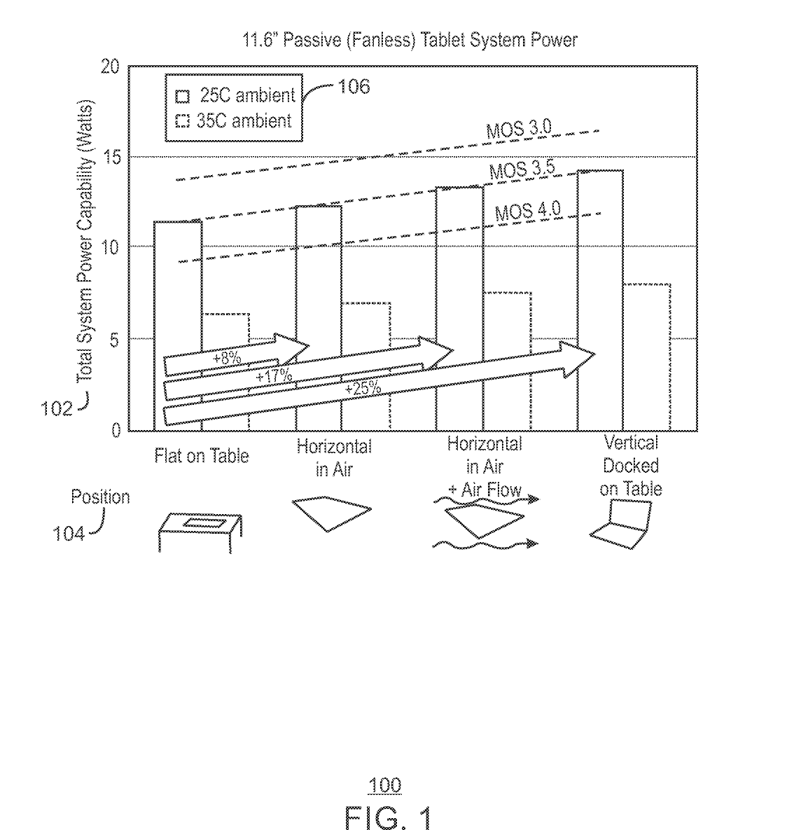

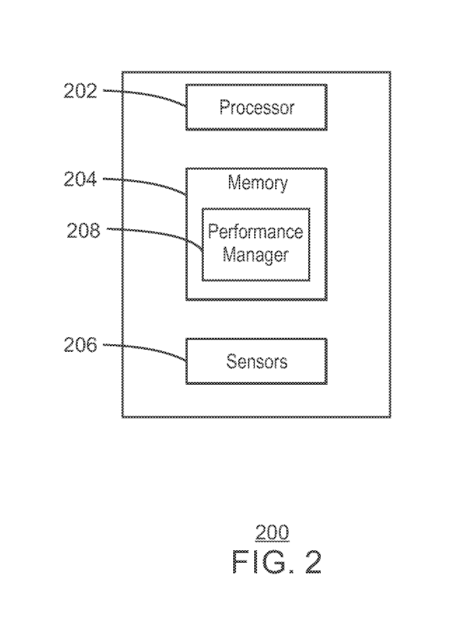

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

In the following description and claims, an embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings or described herein need not be arranged in the particular way illustrated and described. Many other arrangements are possible according to some embodiments.

In each figure, elements may each have a same reference number or a different reference number to suggest that the elements represented could be different or similar. However, an element may be flexible enough to have different implementations and work with some or all of the systems shown or described herein. The various elements shown in the figures may be the same or different. Which one is referred to as a first element and which is called a second element is arbitrary.

In mobile computing devices, such as tablets and convertibles, thermal capability is based on temperature limits for the surface of the device, also referred to herein as Tₛₖᵢₙ limits. These limits relate to the comfort and safety of the device, and can be ranked using a Mean Opinion Score (MOS). The MOS is a numeric rating, where lower scores represent devices that are less comfortable, and less safe. Higher scores indicate safer and more comfortable devices.

The sustained power requirement to meet Tₛₖᵢₙ requirements for mobile devices depends on whether the device is positioned on a flat surface, or if it is held at an angle. In devices where no skin temperature monitoring capability exists, the worst case usage is assumed in order to avoid exceeding Tₛₖᵢₙ limits. Accordingly, the power limits in these devices could result in constrained performance. However, in an embodiment of the claimed subject matter, a mobile device can maximize performance based on the hold position of the device.

FIG. 1 is a graph 100 showing power capability for an example mobile device in different positions, in accordance with embodiments. The graph includes a y-axis 102 for system power capability, x-axis 104 for position, and a legend 106 showing the usage ambient of the environment. The usage ambient is the room temperature. As shown, the power consumed can be adjusted based on the position of the device and the usage ambient. The arrows indicate the amount of increase between the “Flat on Table,” position and each of the “Horizontal in Air,” “Horizontal in Air with Airflow,” and, “Vertical Docked on Table,” positions. Further, the graph 100 shows the MOSs can remain constant, even as power consumption increases.

The original equipment manufacturer, or design manufacturer (OEM or ODM), may predefine power limiting parameters that enable mobile computing devices to automatically adjust power consumption in real-time. In this way, power is automatically adjusted to stay within a power limits set.

The PL1 can be a power limiting parameter for the memory or the processor. The term, PL1 PKG DDR, refers to the memory parameter.

The term, PL1 PKG, refers to the PL1 parameter for the processor. The PL1 PKG is an averaged power limit that a processor controls based on a time constant, Tau. Typically, many mobile devices are configured with a static PL1 PKG that is based on an assumed usage ambient, hold position, and target MOS temperature. The hold position is the position of the device in relation to gravity. For example, for a tablet set flat on a surface top, the amount of cooling from radiant heat transfer is less than when a user is holding the device such that the CPU is positioned vertically, or at an angle, with respect to gravity.

FIG. 2 is a schematic diagram of a system 200 for managing component performance, in accordance with embodiments. The system 200 is a mobile electronic device, such as a tablet, smartphone, convertible, and the like. The system 200 includes a computer processor 202, a memory 204, and sensors 206. The memory 204 includes a performance manager 208. The performance manager 108 manages the thermal capability of the system 100 based on the tilt of the system.

The sensors 206 may include a gyrosensor, proximity sensor, tilt sensor, accelerometer, kickstand position detector, and the like. Gyrosensors determine orientation with respect to gravity. This performance manager 208 uses the current device tilt condition, and automatically modulates the PL1 PKG. Additionally, the performance manager 208 may also use proximity sensors, or accelerometers to determine if the system's boundary condition changes, such as if the system is sitting flat on a table, inside of a bag, being held in the air, etc. In this way, the performance manager 208 may further adjust the PL1 PKG setting being used.

The performance manager 208 uses the PL1 PKG as a dynamic system on a chip (SOC) power limiter. Additionally, the performance manager 208 may also set power limits for memory, wireless bandwidth, display brightness, and so on, based on environmental information from the sensors 206.

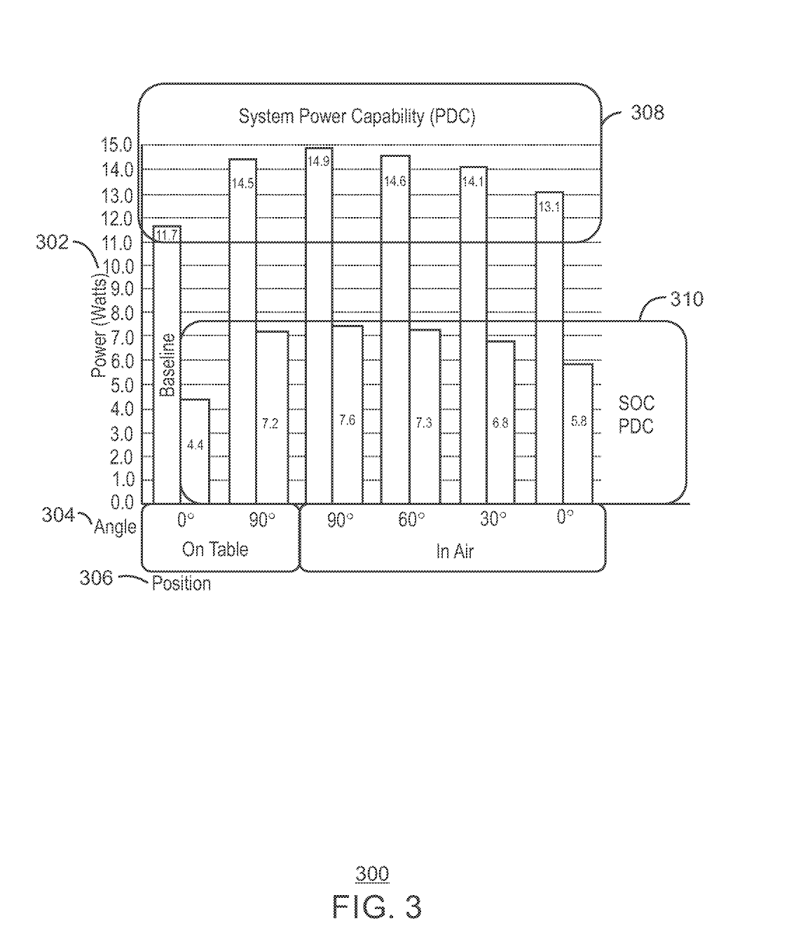

FIG. 3 is a graph 300 showing power dissipation capability with respect to device angle and position, in accordance with embodiments. The graph 300 includes a y-axis 302 for power in watts, an x-axis for angle 304 and user hold position 306.

Data shown above is based on a simulation of an 11.6″ display 10 mm thick tablet at 25 degrees Celsius usage ambient. For each case, the boundary condition assumes the same platform design constraints and shows the amount of Power Dissipation Capability (PDC) for the entire System 308 and just the SOC 310.

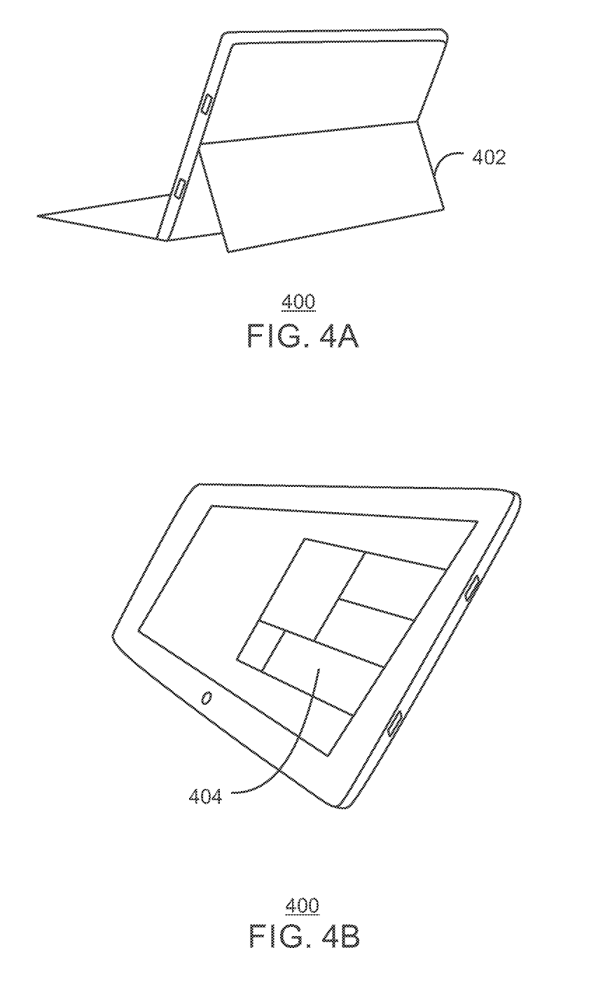

FIG. 4A is a block diagram of a system 400 for managing component performance, in accordance with embodiments. The system 400 includes a kickstand 402. When the kickstand 402 is deployed, the thermal manager 297 may assume the system 400 is set on a table top, or propped up in the user's lap.

With the kickstand 402 deployed, the end user does not have physical contact to the hot spot of the system. As such, higher Tskin temperatures may be tolerable, which would allow for higher energy use, and thus, higher performance. FIG. 4B is a block diagram of the system 400 for managing component performance, in accordance with embodiments. The system 400 includes a touch interface 404, used to operate the system 400.

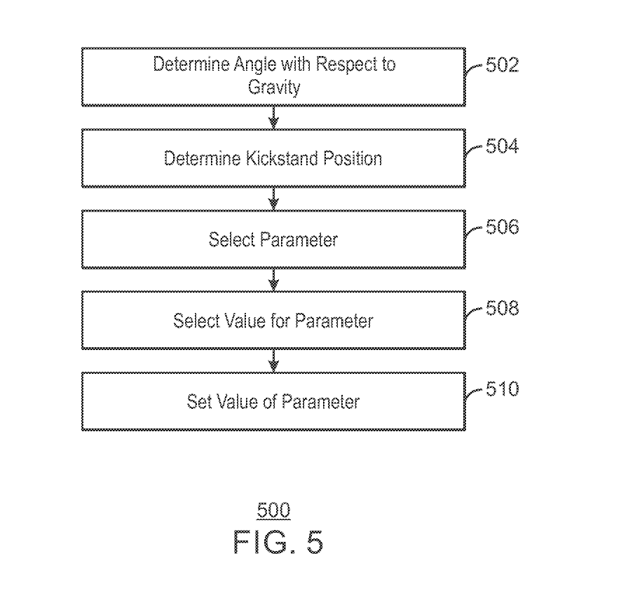

FIG. 5 is a process flow diagram showing a method 500 for managing thermal capability of an electronic device, in accordance with embodiments. The method 500 is performed by the performance manager 208, and begins at block 502, where the angle of the device is determined with respect to gravity. This information may be provided by the sensors 206. The kickstand position may also be determined by the sensors 206. At block 504, the kickstand position may be determined.

At block 506, the parameter to be adjusted is selected. For example, to adjust power consumption for the CPU, the PL1 PKG may be selected. To adjust power consumption for the memory, PL1 PKG DDR may be selected. In one embodiment, the performance manager 208 may determine whether the kickstand 402 is deployed. If so, the PL1 PKG or MOS may be selected.

At block 508, the value of the parameter may be selected. The value is based on the sensor information provided. At block 510, the parameter value may be set to the selected value. In an embodiment using the kickstand 402, a new PL1 PKG level may be set in response to the kickstand 402 being deployed. In another embodiment, the PL1 PKG may be set dynamically based on a Tₛₖᵢₙ temperature sensor-based algorithm working to a new allowable limit. In embodiments where the MOS is selected because the kickstand is deployed, a higher MOS may be set, allowing the component to use more energy for higher performance.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the present techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. A method for managing component performance of an electronic device, comprising:
determining an angle of a computer processor with respect to gravity, the electronic device comprising a computer processor;
selecting a parameter for the computer processor, a speed of the computer processor being based on the parameter;
selecting a value of the parameter based on the angle; and
setting the value of the parameter based on the selection.

2. The method of claim 1, comprising:
determining a proximate environment of the electronic device; and
selecting the value of the parameter is based on the proximate environment.

3. The method of claim 2, the proximate environment comprising one of:
a deployed kickstand supporting the electronic device;
a surface supporting the electronic device;
an air flow in contact with the electronic device; and
an enclosure surrounding the electronic device.

4. The method of claim 1, comprising:
determining an ambient temperature of the electronic device; and
selecting the value of the parameter based on the ambient temperature.

5. The method of claim 4, the electronic device comprising a sensor configured to determine the ambient temperature.

6. The method of claim 1, the parameter being a PL1 PKG of the computer processor.

7. The method of claim 1, the electronic device comprising a sensor configured to determining the angle with respect to gravity.

8. The method of claim 7, the electronic device comprising a gyroscope and a tilt sensor.

9. An electronic device, comprising:
a computer processor;
a sensor configured to determine an angle of the computer processor with respect to gravity; and
a memory comprising code executable by the computer processor to:
determine, using the sensor, the angle of the computer processor with respect to gravity;
select a parameter for the computer processor, a speed of the computer processor being based on the parameter;
select a value of the parameter based on the angle; and
setting the value of the parameter based on the selection.

10. The electronic device of claim 9, comprising:
determining a proximate environment of the electronic device; and
selecting the value of the parameter is based on the proximate environment.

11. The electronic device of claim 10, the value being selected in response to a deployment of a kickstand of the electronic device.

12. The electronic device of claim 11, the code being executable by the computer processor to select the value based on a predefined value.

13. The electronic device of claim 11, the code being executable by the computer processor to dynamically select the value based on a temperature of a skin of the electronic device.

14. The electronic device of claim 9, the parameter being a PL1 PKG of the computer processor.

15. The electronic device of claim 9, the sensor configured to determining the angle with respect to gravity comprising one of a gyroscope and a tilt sensor.

16. A computer-readable medium, comprising computer instructions configured to cause a computer processor to:
determine an angle of a computer processor with respect to gravity, the electronic device comprising a computer processor and a sensor configured to determining the angle with respect to gravity;
determine a proximate environment of the electronic device;
select a parameter for the computer processor, a speed of the computer processor being based on the parameter;
select a value of the parameter based on the angle and the proximate environment of the electronic device; and
set the value of the parameter based on the selection.

17. The computer-readable medium of claim 16, the proximate environment comprising one of:
a surface supporting the electronic device;
an air flow in contact with the electronic device; and
an enclosure surrounding the electronic device.

18. The computer-readable medium of claim 16, comprising:
determine an ambient temperature of the electronic device; and
select the value of the parameter based on the ambient temperature.

19. The computer-readable medium of claim 18, the electronic device comprising a sensor configured to determine the ambient temperature.

20. The computer-readable medium of claim 16, the parameter being a PL1 PKG of the computer processor.
